(19) United States
(12) Patent Application Publication
(10) Pub. No.: US 2005/0155209 A1
(43) Pub. Date: Jul. 21, 2005

(54) Positive pipe interlock

(75) Inventors: Jules Isendam, Etobicoke (CA); Michael Brunt, Newmarket (CA); Wayne Gooderham, Etiobicoke (CA)

Correspondence Address: Bourque & Associates, P.A., Suite 301, 835 Hanover Street, Manchester, NH, 03104, US

(73) Assignee: Flexmaster Canada Limited

(21) Appl. No.: 10/761,125

(22) Filed: Jan. 20, 2004

(51) Int. Cl. B23P 11/02; F16L 25/00

(52) U.S. Cl. 29/453; 29/446; 29/450; 285/330

(57) ABSTRACT

A system and method is taught of positively joining to pipes, such as stovepipe or conduit. A first pipe is made with an indentation about the perimeter of one end, into which a second pipe is fitted snugly. The second pipe has a plurality of protrusions about the perimeter near the end to be inserted into the first pipe. The protrusions are shaped so as to allow passage past the indentation in the first pipe during insertion of the second pipe, while resisting disassembly by withdrawing the second pipe.

### TECHNICAL FIELD

The present invention relates to pipe interconnections and more particularly, to a method and system of interconnecting pipe and to a pipe manufactured with a novel interconnection system.

### BACKGROUND INFORMATION

Thin-walled pipe and conduit is used for a variety of purposes. For example, thin-walled metal pipe is used as chimney pipe for wood stoves. Round and rectangular thin-walled conduit is used in distributing hot air in a heating system or air conditioning system. Double walled pipe may be used to vent a furnace.

Depending upon the application, such pipes may be made from stainless or galvanized sheet metal steel, or may be made from a flexible plastic material. The pipes may be single walled or multiple walled, multiple walled pipes typically being used to provide a thermal insulating layer between the pipe contents and the outer wall of the pipe.

Such pipes typically come in fixed lengths, and are expanded in diameter at one end so as to be able to be slided over the next section of pipe. Depending upon the application, the connection between pipes may need to be sealed, such as by using duct tape or a gasket.

It is desirable to be able to have joined pipes positively connected in place so as to prevent slippage or disassembly, and to avoid a gasket or duct tape seal from working loose due to relative pipe movement. It is also desirable to be able to hold the pipe in place during installation and later during use. Indeed, it is often a building code requirement that such pipes be mechanically fastened in some way such as by using sheet meal screws or a clamp.

Known methods to join pipe pieces together include inserting one or more screws at the point of overlap between two pieces of pipe. This requires drilling or punching, and manually installing screws, which can be both time consuming and expensive. Moreover, such a method does nothing to hold the pipe in place while it is being installed.

Another known method is to use an external ring or band to fasten two pieces of pipe together, with each piece of pipe having something for the external ring to grip, such as a bead or ridge. Again, this requires the expense of an additional piece and the associated assembly time, as well as doing nothing to hold the pipe in place during installation.

Yet another known method of holding pipes together is to provide one or more “L” shaped channels in the receiving pipe, and one or more corresponding pins in the mating pipe. The pins on one pipe are lined up with the associated channels on the second pipe into which the first pipe is to be installed, the pipes pressed together into place, and then twisted to lock in place. This gives a positive lock during installation, but may prove difficult to install when joining pipes that must be joined at a set orientation (such as an elbow) because the desired angle at which the pipes lock together may or may not be the angle desired for the particular installation. Moreover, twisting the inner pipe to cause locking may be difficult because of friction between the inner and outer pipes.

### SUMMARY

The present invention features a system and method for positively joining two pipes, such as stovepipe or conduit. A first pipe is made with an indentation about the perimeter of one end, into which a second pipe may be snugly fitted. The second pipe has one or more protrusions about the perimeter near the end to be inserted into the first pipe. The protrusions are shaped so as to allow passage past the indentation in the first pipe during insertion of the second pipe, while resisting disassembly by withdrawing the second pipe. In one embodiment, the protrusions are wedge shaped. In another embodiment, the protrusions are hemispherical. The principles of the present invention are applicable to multi-walled pipes as well.

### BRIEF DESCRIPTION OF THE DRAWINGS

These and other features and advantages of the present invention will be better understood by reading the following detailed description, taken together with the drawings wherein:

FIG. 1 is a drawing of two pipes made in accordance with the principles of the present invention;

FIGS. 2 and 3 are cross-sectional views of a portion of one edge of two pipes at the point of interlock, in accordance with the principles of the present invention; and

FIG. 4 is a cross-sectional view of a portion of one edge of two double walled pipes in accordance with the principles of the present invention.

### DETAILED DESCRIPTION OF THE PREFERRED EMBODIMENTS

The present invention provides a method and system for positively joining two pipes. No additional parts are required to effectuate the positive interlock, which may, when the pipes are made of a suitable deformable elastically material such as sheet metal, be disassembled.

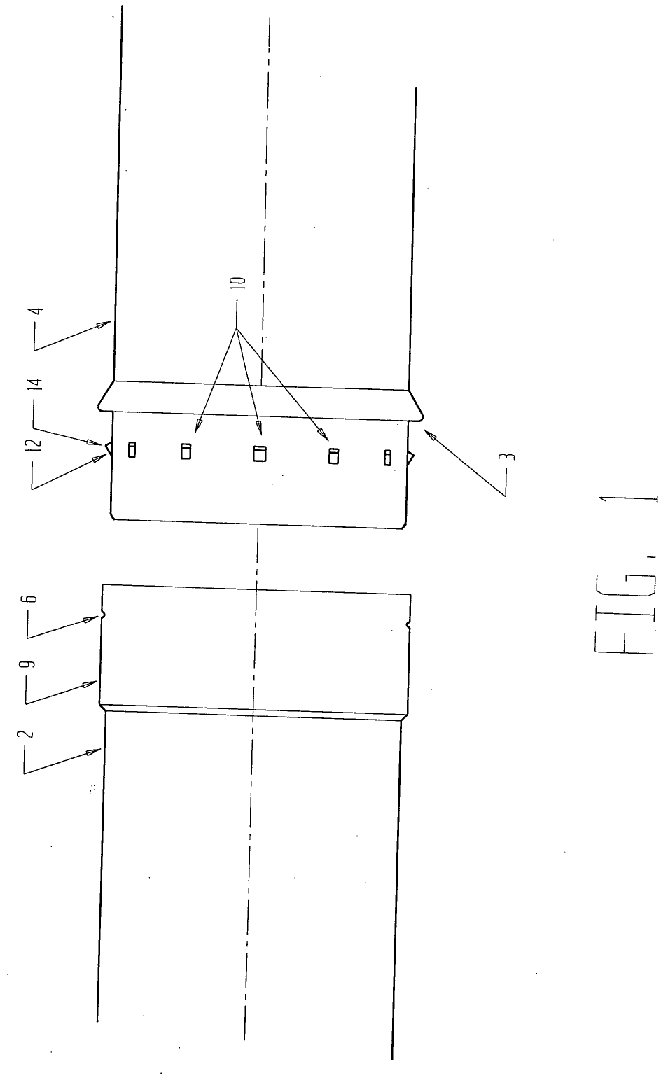

Referring to FIG. 1, two pipes made according to the principles of the present invention are shown. A first pipe 2 has one end expanded so it slides over the protrusion 10 of the second pipe 4 and has an indentation 6 about the perimeter. This indentation, in the case of pipe made from sheet metal, may easily be made in a rolling operation.

Spaced about the circumference of the end of the second pipe 4 are a number of protrusions 10 located so that, when the expanded size portion 9 of the first pipe 2 is sliding over the end of the second pipe 4, the protrusions 10 may slide tightly past the indentation 6. In the present example, the protrusions 10 are wedge shaped, with the thin edge of the wedge 12 oriented such that as the second pipe 4 is inserted into the first pipe 2, the protrusions 10 present a gradually inclined surface against the indentation 6. This results in gradually squeezing and elastically deforming the increased diameter of end portion 9 of the first pipe 2, until the thick end 14 of the wedge passes by the indentation 6. When in place, the first pipe 2 snaps back into its original shape and the thick end 14 of the wedge shaped protrusion 10 passes by and engages against the indentation 6 preventing the two pipes 2 and 4 from thereafter being separated.

The size and shape of both the indentation 6 and protrusions 10 may be varied depending upon the application, and the desirability of being able to disassemble the joined pipes. Disassembly may be accomplished by squeezing the second pipe to allow re-passage of a protrusion 10 past the indentation 6. The indentation is structurally most sound where it has no sharp corners, but sharp corners may be used to provide a more positive lock, although making disassembly more difficult.

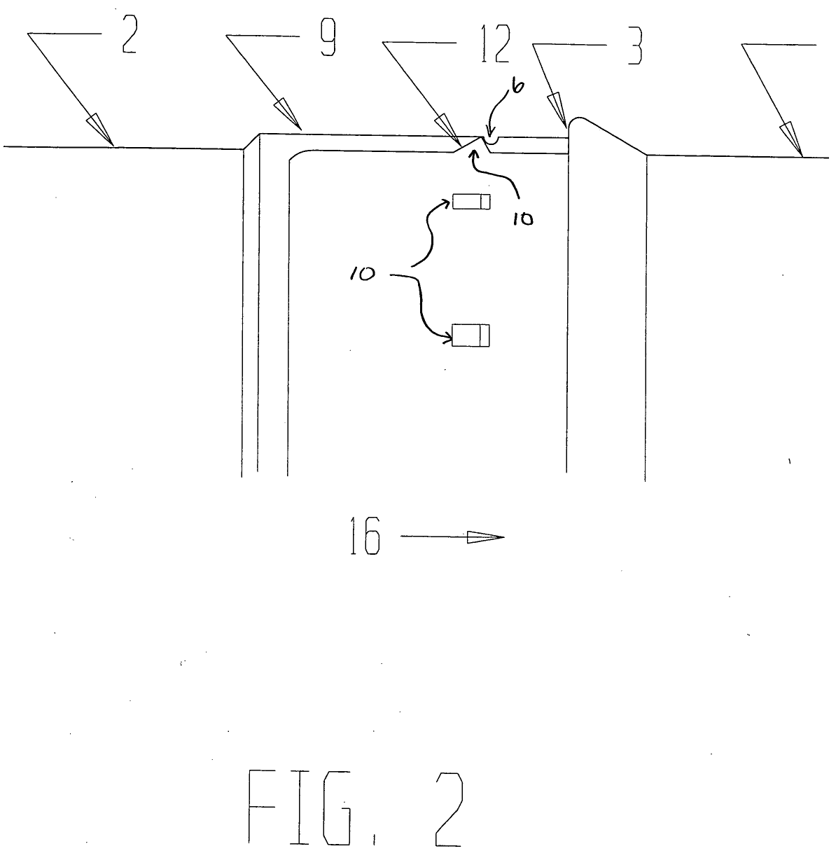

Referring to FIG. 2, a cross sectional view of one side of the intersection of two pipes 2 and 4 joined in accordance with the principles of the present invention is shown. In this example, the protrusion 10 is wedge shaped with a thinner edge portion 12 to aid when inserting the second pipe 4 into the first pipe 2. An expanded region or protrusion 3 is shown engaged against the end of the first pipe 2 preventing the first pipe 2 from being moved relative to the second pipe 4 in the direction of the arrow 16. The expanded region or protrusion 3 is disposed a distance away from the end of the second pipe 4, further than the protrusions 10. In this example, the indentation 6 is made such that it presses firmly against the protrusion 10 in pipe 4 when the expanded end 9 of pipe 2 springs back to its normal shape.

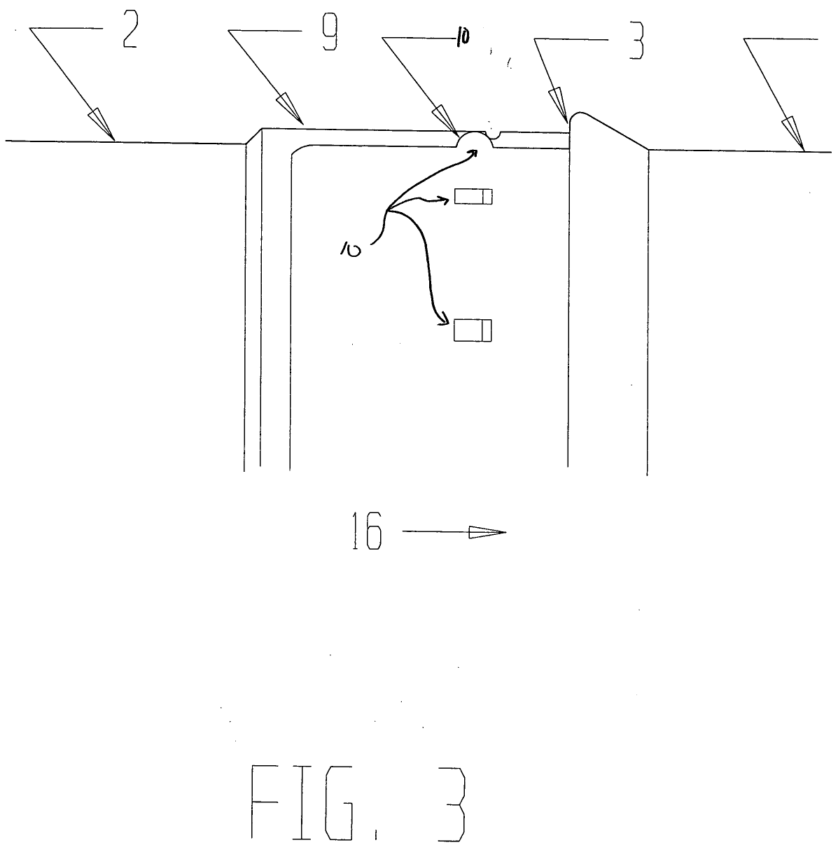

FIG. 3 shows a cross sectional view of one side of the intersection of two pipes 2 and 4 joined in accordance with the principles of the present invention. In this instance, the protrusion 10 is more rounded and less wedge shaped. Such a shape for the protrusions 10 allows for easier disassembly at the potential cost of a less positive interlock. The protrusions 10 may be hemispherical, or may be in the shape of ridges, with the longitudinal axis of the ridge parallel to a plane normal to the longitudinal axis of the second pipe 4.

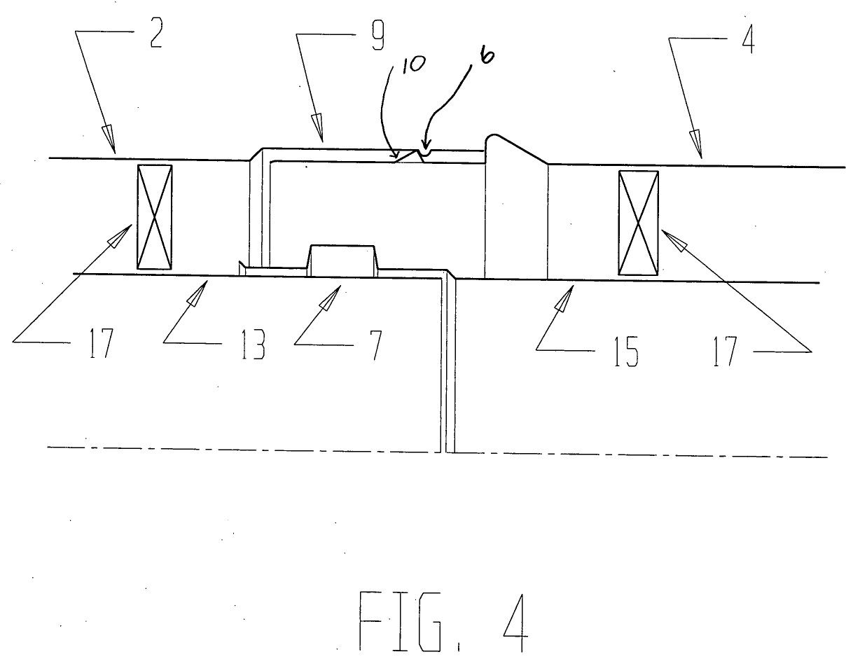

The principles of the present invention are readily applicable to multi-walled pipes. FIG. 4 shows a cross sectional view of one side of the intersection of two double walled pipes in accordance with the principles of the present invention. The first pipe 2 includes an indentation 6. The first pipe 2 also includes an inner pipe wall 3, held in position relative to the first pipe 2 by a spacer 17. Similarly, the second pipe 4 has an inner pipe 5 held in position relative to the second pipe 4 by a spacer 17. The protrusion 10 on the second pipe 4 is shown engaged with the indentation 6. The inner pipes 3 and 5 have a region of overlap 7, which may be fitted with a gasket (not shown).

In an exemplary implementation, a fourteen-inch circular cross section double walled pipe, having an inner pipe of 12 inches, was made with an indentation in the outer wall of the first pipe 2 three-sixteenths inches deep. A plurality of protrusions 10 were evenly spaced along the circumference of the second pipe 4. The protrusions 10 were wedge shaped, one-sixteenth inch high and one-quarter inch wide. The inner pipes 13 and 15 were fitted with a gasket at the region of overlap 7.

Modifications and substitutions by one of ordinary skill in the art are considered to be within the scope of the present invention, which is not to be limited except by the following claims. For example, instead of an indentation ring 6, the indentation 6 may comprise a plurality of discrete indentation regions. Further, the second pipe 4 may be made with a protrusion ring or protrusion segments 6 into which the protrusions 10 of the first pipe 2 may engage.

1. A method for joining pipes, comprising the acts of:
providing a first pipe having an indentation directed generally radially inward about a perimeter of said first pipe a predetermined distance from a first end of said first pipe, said indentation having an outer side and an inner side with respect to said first end of said first pipe;
providing a second pipe having a first end region including a first and at least a second protrusion each having an engaging surface and extending generally radially outward about a perimeter of said first end region a first and a second spaced distance from a first end of said second pipe respectively; and
assembling said first end region of said second pipe about said first end of said first pipe such that during assembly, said at least one protrusion on said first end region of said second pipe is forced past said indentation on said first end of said first pipe such that said engaging surface of said at least one protrusion engages against said inner side of said indentation when said first and said second pipes are joined.

2. The method of claim 1 wherein at least one of said first and said second pipes is thin walled and made from a generally deformable material.

3. The method of claim 1 wherein said first end region of said first pipe further includes an internal cross section that is larger than an external cross section of first end region of said second pipe such that said second pipe fits generally within said first end region of said first pipe.

4. The method of claim 3 wherein said second spaced distance of said second protrusion is greater than said first spaced distance of said first protrusion, wherein said first protrusion and said at least a second protrusion prevent said first end of said first pipe from moving relative to said second pipe.

5. The method of claim 2 wherein at least said first protrusion is wedge shaped with a thin end and a thick end, and oriented so that said thin edge of said wedge is closer to said first end than said thick end, and longitudinally oriented parallel to a longitudinal axis of said second pipe.

6. The method of claim 5 wherein at least said inner side of said indentation is shaped to match the longitudinal cross sectional shape of said thick end of at least said first protrusion.

7. The method of claim 2 wherein said at least said first protrusion is hemispherical.

8. The method of claim 2 wherein at least said first protrusion forms a ridge having a longitudinal axis perpendicular to the longitudinal axis of said second pipe.

9. The method of claim 2 wherein said first and said second pipes are dual walled.

10. The method of claim 2 wherein at least one of said first and said second pipes is made from an elastically deformable material such that during assembly of said first and said second pipes, said at least one protrusion being forced by said indentation causes at least some deformation of at least one of said first and said second pipes.

11. The method of claim 1 wherein said indentation in said first pipe includes an indentation ring disposed generally about the circumference of said first end of said first pipe.

12. The method of claim 1 wherein said first and said at least a second protrusion includes at least a third protrusion.

13. The method of claim 1 wherein said at least one protrusion includes a protrusion ring disposed generally about the circumference of said first end of said second pipe.

14. A system for joining pipes, comprising:
a first pipe having an indentation directed generally radially inward about a perimeter of said first pipe a predetermined distance from a first end of said first pipe, said indentation having an outer side and an inner side with respect to said first end of said first pipe;
a second pipe having a first end region including a first and at least a second protrusion extending generally radially outward about a perimeter of said first end region, said first and said at least a second protrusion each having an engaging surface adapted to engage said inner side of said indentation and lock said first and said second pipes into a fixed position relative to each other.

15. The system of claim 14 wherein at least one of said first and said second pipes is thin walled and made from a generally deformable material.

16. The system of claim 14 wherein said first end region of said first pipe further includes an internal cross section that is larger than an external cross section of first end region of said second pipe such that said second pipe fits generally within said first end region of said first pipe.

17. The system of claim 14 wherein said first end region of said second pipe further includes an internal cross section that is larger than an external cross section of first end region of said first pipe such that said first pipe fits generally within said first end region of said second pipe.

18. The system of claim 16 wherein said first and said at least a second protrusion are disposed a first and a second spaced distance from said first end of said second pipe respectively, wherein said second spaced distance is greater than said first spaced distance and said first and said at least a second protrusion prevent said first end of said first pipe from moving relative to said second pipe.

19. The system of claim 15 wherein at least said first protrusion is wedge shaped with a thin end and a thick end, and oriented so that said thin edge of said wedge is closer to said first end than said thick end, and longitudinally oriented parallel to a longitudinal axis of said second pipe.

20. The system of claim 19 wherein at least said inner side of said indentation is shaped to match the longitudinal cross sectional shape of said thick end of at least said first protrusion.

21. The system of claim 16 wherein said at least one protrusion is hemispherical.

22. The system of claim 15 wherein at least said first protrusion forms a ridge having a longitudinal axis perpendicular to the longitudinal axis of the second pipe.

23. The system of claim 15 wherein said first and said second pipes are dual walled.

24. The system of claim 15 wherein at least one of said first and said second pipes is made from an elastically deformable material such that during assembly of said first and said second pipes, at least said first protrusion being forced by said indentation causes at least some deformation of at least one of said first and said second pipes.

25. The system of claim 14 wherein said indentation in said first pipe includes an indentation ring disposed generally about the circumference of said first end of said first pipe.

26. The system of claim 14 wherein said first and said at least a second protrusion includes at least a third protrusion.

27. The system of claim 14 wherein at least said first protrusion includes a protrusion ring disposed generally about the circumference of said first end of said second pipe.

28. A pipe comprising:
a first end having an indentation extending generally radially inward around a circumference, said indentation having an outer side and an inner side, said outer side being closer to said first end than said inner side; and
a second end having an external diameter that is smaller than an internal diameter of said first end, said second end having a first and at a least second protrusion, disposed a first and a second distance from said second end respectively wherein said second spaced distance is larger than said first spaced distance.
